(19) United States
(12) Patent Application Publication
(10) Pub. No.: US 2014/0226893 A1
(43) Pub. Date: Aug. 14, 2014

(54) Method and System for Image-Based Defect Alignment

(71) Applicant: TAIWAN SEMICONDUCTOR MANUFACTURING COMPANY, LTD., (US)

(72) Inventors: Jen-Chieh Lo, New Taipei City (TW); Tzu-Chin Lin, Hsinchu City (TW); Chia-Cheng Chang, Zhubei City (TW); Ying-Chou Cheng, Zhubei City (TW); Ru-Gun Liu, Zhubei City (TW); Cheng Yi Hsieh, New Taipei City (TW); Wen-Feng Chiu, Zhubei City (TW); To-Yu Chen, Yun-Line (TW)

(73) Assignee: TAIWAN SEMICONDUCTOR MANUFACTURING COMPANY, LTD., Hsin-Chu (TW)

(21) Appl. No.: 13/763,809

(22) Filed: Feb. 11, 2013

(51) Int. Cl. G06T 7/00

(52) U.S. Cl. CPC G06T 7/0004
USPC 382/149

(57) ABSTRACT

The present disclosure provides one embodiment of a method for defect diagnosis to a semiconductor wafer. The method includes collecting raw data that include a defect image (IMG), defect coordinate-on-wafer (CW) and layout database (DB); performing an image-based defect alignment to IMG according to CW and DB; and compensating coordinate mismatch according to the image-based defect alignment.

### BACKGROUND

In semiconductor technology, integrated circuit (IC) wafers, each having multiple chips, are produced by a plurality of processes in a wafer fabrication facility (fab). Each process can introduce one or more defects to the IC wafers, which leads to quality and reliability issues, failures, and yield losses. To improve manufacturing technologies and enhance chip (wafer) quality, reliability, and yield, the semiconductor wafers are measured, tested, monitored, diagnosed. In one example, the defect diagnosis includes defect binning, which is achieved by defect pattern grouping. However, current practices have concerns associated with coordinate offset. The coordinate offset is unavoidable key issue in coordinate transformation and causes errors and inaccuracy in the defect diagnosis, such as defect binning. Therefore, a system and a method for defect diagnosis are needed to address the above issues.

### BRIEF DESCRIPTION OF THE DRAWINGS

Aspects of the present disclosure are best understood from the following detailed description when read with the accompanying figures. It is emphasized that, in accordance with the standard practice in the industry, various features are not drawn to scale. In fact, the dimensions of the various features may be arbitrarily increased or reduced for clarity of discussion.

FIG. 1 is a simplified flowchart of a method for defect diagnosis that includes coordinate-mismatch compensation, constructed according to various aspects of the present disclosure in one embodiment.

FIG. 2 is a simplified flowchart of a method for image-based defect alignment, constructed according to various aspects of the present disclosure in one embodiment.

FIG. 3 is a schematic view of a substrate having defects in one example.

FIG. 4 is a block diagram of one embodiment of a system for defect diagnosis with coordinate-mismatch compensation, constructed according to various aspects of the present disclosure in one embodiment.

FIG. 5 is a block diagram of one embodiment of an image-based defect alignment module, constructed according to various aspects of the present disclosure in one embodiment.

FIG. 6 is a block diagram of one embodiment of a virtual fabrication system within which the system of FIG. 4 may be incorporated.

### DETAILED DESCRIPTION

It is to be understood that the following disclosure provides many different embodiments, or examples, for implementing different features of the invention. Specific examples of components and arrangements are described below to simplify the present disclosure. These are, of course, merely examples and are not intended to be limiting. In addition, the present disclosure may repeat reference numerals and/or letters in the various examples. This repetition is for the purpose of simplicity and clarity and does not in itself dictate a relationship between the various embodiments and/or configurations discussed.

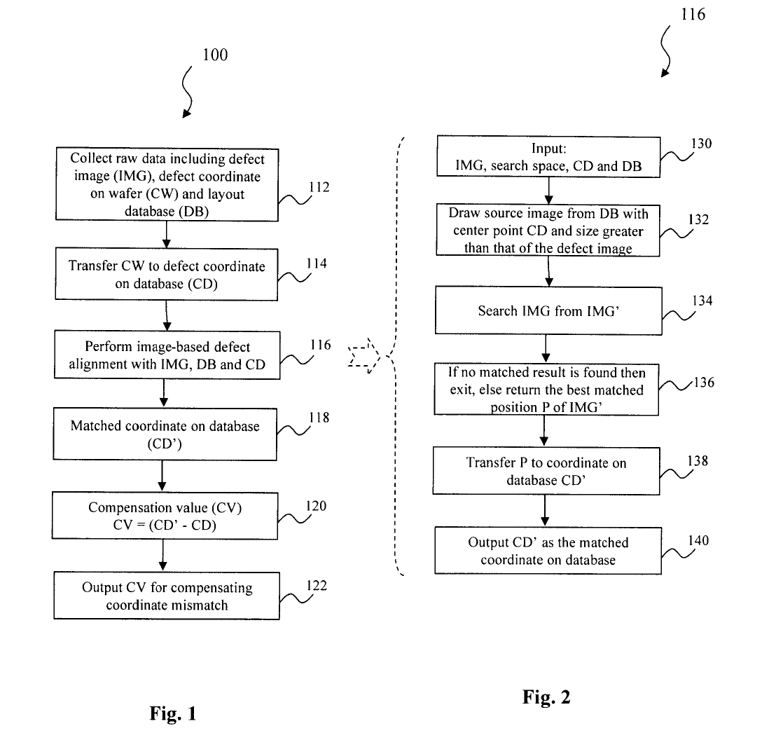

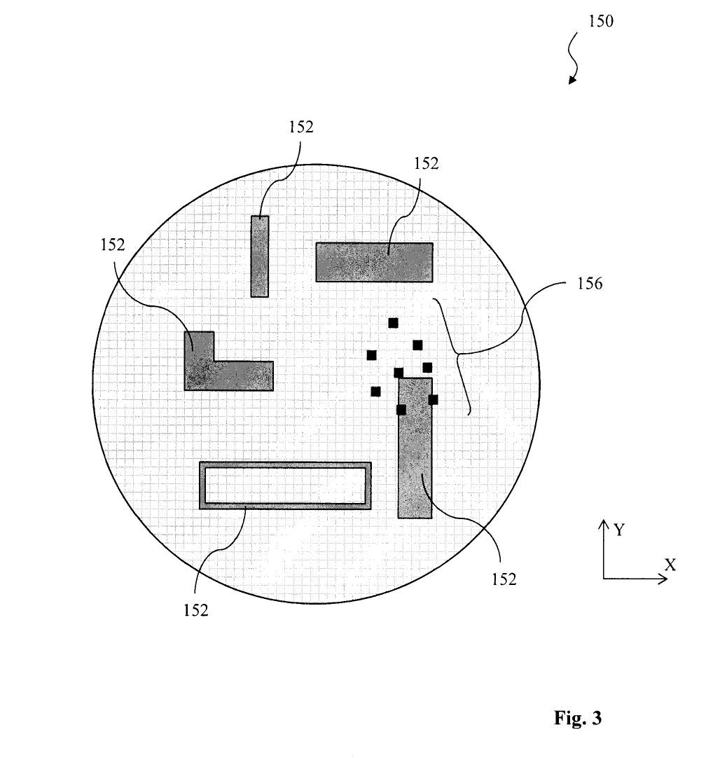

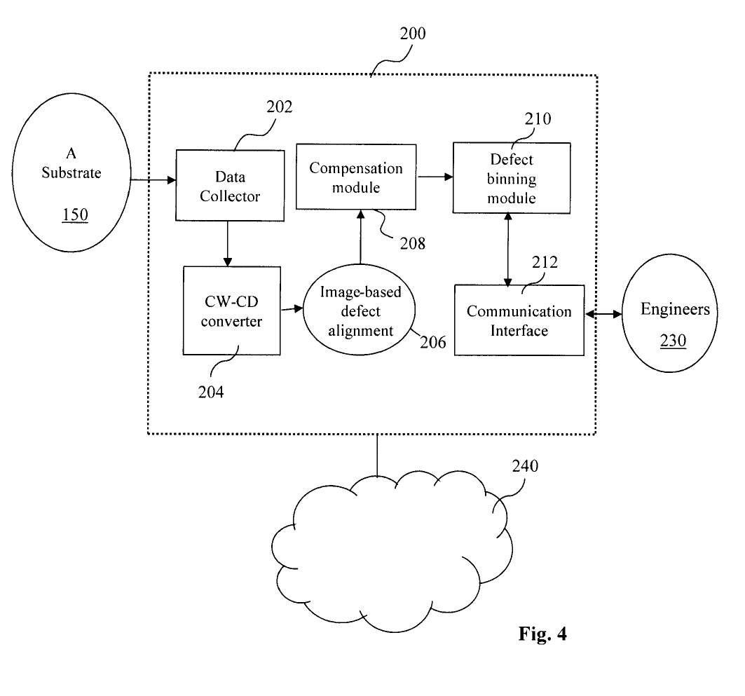

FIG. 1 is a simplified flowchart of a method 100 for diagnosing a defect image, constructed according to aspects of the present disclosure in one or more embodiment. FIG. 2 is a simplified flowchart of a method for image-based defect alignment, constructed according to aspects of the present disclosure in one or more embodiment. FIG. 3 is a schematic view of a substrate having defects in one example. The method 100 is described with reference to FIGS. 1-3.

The defect image is extracted from a substrate processed in a semiconductor fabrication facility (fab). In one embodiment, the substrate is a semiconductor substrate (wafer). Alternatively, the substrate is a photomask (mask), or other substrates such as a thin-film-transistor liquid crystal display (TFT-LCD) substrate processed in a semiconductor fabrication. In the following description, the substrate is a wafer. A wafer goes through a plurality of processes in a semiconductor fabrication that form multiple chips (dies) on the wafer. Each chip includes a functional integrated circuit. Each process may introduce defects to the wafer, including physical defects, electrical defects, and other types of defects. The physical defects may include scratches, contaminations, and particles, chipping, and cracks. The electrical defects may include shorts, open lines, and out of specification electrical parameters (such as sheet resistance).

FIG. 3 illustrates a substrate 150, such as a semiconductor wafer. The substrate 150 is fabricated to form a main pattern 152, such as integrated circuit (IC) pattern. In the present example, the substrate 150 also includes various defects 156 introduced during the semiconductor fabrication. These defects may be inspected and measured by a defect metrology tool, such as a light-scattering tool, a scanning electron microscope (SEM) or other suitable defect imaging tools.

Defect diagnosis is a procedure of analyzing the defects that aids in failure mode analysis and leads to root cause(s) identification. In various embodiments, the defect diagnosis may include classifying the defects, characterizing the defects and finding the root cause(s). In one example, the defect diagnosis includes defect binning according to one or more factors, such as defect locations. However, various errors may be introduced to defect location during the defect diagnosis. The method 100 provides a procedure for defect diagnosis with coordinate-mismatch compensation.

The method 100 begins at operation 112 by collecting (or receiving) raw data associated with defect on the substrate. In the present embodiment, the raw data includes defect image (IMG), defect coordinate on wafer (CW) and layout database (DB). These terms are further explained with reference to FIG. 3.

As illustrated in FIG. 3, the substrate 150 includes the main pattern 152. The main pattern 152 is defined in the layout database (DB) and is transferred to the substrate 150 by a suitable fabrication technology, such as lithography patterning and etching. The defects 156 are introduced to the substrate 150 during the fabrication. The defect image (IMG) is extracted from the substrate 150 by a suitable metrology tool, such as a light-scattering tool. The defect image (IMG) is an image of the substrate 150 in portion. The location of IMG is represented by the defect coordinate on wafer (CW). In the present embodiment, CW is the coordinate of the central location of the defects 156 on the substrate 150. For example, CW is represented by (X, Y) in Cartesian coordinate system relative to the substrate 150. X and Y are coordinate axes that are perpendicular to each other and are defined on the plane of the substrate 150. The size of IMG may be chosen such that the defect image (IMG) includes the defects 156 in cluster (or referred to as a defect pattern). The size of IMG is further described at a later stage. The defect image (IMG) includes the main pattern 152 transferred from the layout database (DB) and the defects 156.

The method 100 proceeds to operation 114 by transferring the coordinate on wafer (CW) to coordinate on database (CD). The coordinate on database (CD) is a coordinate representation of a location relative to the layout database (DB). Since the CW is defined relative to the substrate 150, CW as the coordinate defined on the substrate 150 is transferred to CD as the coordinate defined on the layout database (DB).

The method 100 proceeds to operation 116 by performing an image-based defect alignment with IMG, DB and CD. In the image-based defect alignment, the coordinate of the defect image (IMG) is identified based on the image matching such that the corresponding coordinate compensation is on the database is extracted. The operation (or method in another word) 116 for the image-based defect alignment is further described with reference to FIG. 2.

The method 116 starts from the input 130 that includes IMG, CD, DB and search space. The search space is defined relative to the size of the defect image (IMG). The size of IMG may be represented in any suitable form. In one embodiment, the size of IMG is represented by (ΔX, ΔY), wherein ΔX is the span of IMG in the X direction and ΔY is the span of IMG in the Y direction.

In another embodiment, the size of IMG is represented by (R, C), wherein R (row) is the span of IMG in the X direction and C (column) is the span of IMG in the Y direction but in different units. For example, the substrate 150 includes a plurality of dies (or chips) formed thereon in an array having multiple rows and multiple columns. The size of IMG defined in (R, C) means that the defect image (IMG) spans a first number (represented by R) of rows and a second number (represented by C) of columns. In another example, the defect image (IMG) includes a plurality of pixels, depending on the resolution of the metrology tool used to capture the defect image (IMG). In this case, the size of IMG defined in (R, C) means that the defect image (IMG) spans a first number (represented by R) of pixels in the X direction and a second number (represented by C) of pixels in the Y direction.

Accordingly, the search space of IMG is expressed similarly. In the present embodiment, the search space is represented by (R′, C′). In the first example associated with the dies arranged in an array, the parameters R′ and C′ mean that the search space spans a first number (represented by R′) of rows and a second number (represented by C′) of columns. In the second example, the parameter (R′, C′) mean that the search space spans a first number (represented by R′) of pixels in the X direction and a second number (represented by C′) of pixels in the Y direction. It is noted that the search space is greater than the size of the defect image (IMG). In the present embodiment, the search space is determined based on the range of the coordinate mismatch such that the corresponding portion of the main pattern in the defect image (IMG) is still included in the source image (IMG′) even there is coordinate mismatch.

The method 116 proceeds to a sub-operation (or simply operation) 132 by extracting (or drawing) a source image (IMG′) based on the defect image (IMG), the layout database (DB) and the coordinate on database (CD′). The source image (IMG′) is an image of the substrate 150 but is directly extracted from the layout database (DB). Therefore, the source image (IMG′) only includes the main pattern 152 but not the defects 156.

The source image (IMG′) is centered at the location defined by the defect coordinate on database (CD) and has a size greater than the size of the defect image (IMG). Particularly, the source image (IMG′) has a size defined by the search space that is greater than the size of the defect image (IMG). In the present example, the source image (IMG′) has a size defined by the search space (R′, C′) while the defect image (IMG) has a size defined by (R, C).

The source image may be extracted from the layout database (DB) by any suitable technique, such as a simulation technique to simulate the fabrication to form the main pattern 152 on the substrate 150.

The method 116 proceeds to an operation 134 by searching IMG from IMG′. During the searching, the defect image (IMG) is identified from a portion of the source image (IMG′) so the main pattern in the defect image (IMG) matches the main pattern of the source image (IMG′) in the corresponding portion. The searching process may utilize any suitable technique, such as any suitable technique for pattern recognition.

In one embodiment of the searching operation, the defect image (IMG) is compared with a portion of the source image (IMG′) to determine if there is a match between the defect image (IMG) and the corresponding portion of the source image (IMG′). If no match, the search process continues by comparing the defect image (IMG) with a different portion of the source image (IMG′). In one example of the comparing process, the defect image (IMG) is mapped to a portion of the source image (IMG′) and is determined if there is a match based on a predefined matching criteria.

In the completion of the operation 134 for the searching, the method 116 proceeds to operation 136. For example, the searching process may be completed if the source image (IMG′) is exhausted. At the operation 136, if no matched result is found, the method 116 stops (or exits). In this case, an engineer may be involved to perform the searching process or to tune search parameters, such as increasing the search space or changing the match criteria.

At the operation 136, if a matched result is found, the corresponding matching position P of the source image (IMG′) is returned or extracted. The matching position P is the position of the matched portion of the source image (IMG′). Particularly, the position P is the central location of the matched portion of the source image (IMG′) in the present example.

In one situation that the searching process may end up with more than one matched portions. In this case, the best matched portion is chosen; the matching position P is the position of the best matched portion of the source image (IMG′).

The method 116 proceeds to an operation 138 by transferring the matching position to a coordinate on database (referred to as matched coordinate on database or CD′). In other words, the matching position P is expressed in the coordinate on database. Usually, CD′ is different from CD due to the coordinate mismatch.

The method 116 ends at 140 with an output CD′ as the matched coordinate on database.

Now returning to the method 100 with reference to FIG. 1, the operation 116 (or method 116) returns CD′ as the matched position on database as shown in block 118.

The method 100 proceeds to an operation 120 by finding a coordinate compensation value (CV). The coordinate compensation value (CV) is associated with the difference between CD′ and CD. Particularly, CV=CD′−CD. It is noted that CV may not be a single number. In the present case, the CV is a pair of numbers that represent coordinate compensation on X and Y directions, respectively.

The method 100 then proceeds to an operation 122 by outputting the coordinate compensation value for compensating coordinate mismatch. In one example, the coordinate on wafer CD for the defect image (IMG) is compensated to eliminate the mismatch. The compensated coordinate on wafer is CD′. In another example, another defect image taken from a different portion of the same substrate 150 is compensated for its coordinate by the coordinate compensation value CV. In yet example, another defect image taken from a different substrate may be compensated for its coordinate by the coordinate compensation value CV.

Although the method 100 has been described in detail, those skilled in the art should understand that they may make various changes, substitutions and alterations herein without departing from the spirit and scope of the present disclosure. For example, some operations in the method may be combined. In another example, one operation may be split into two or more separate operations.

In another embodiment, the method 100 may be repeated after a period of time for recapturing the coordinate compensation value (CV) since the coordinate mismatch may drift over time. In yet another embodiment, the method 100 further includes operations for defect diagnosis (or analysis) to those defect images after coordinate compensation. In one example, the defect diagnosis includes a defect binning process.

In another example, the defect diagnosis includes an operation to extract one or more characteristics from the defect image. The characteristic extraction process may extract pattern parameters, such as average pattern density, core pattern density, edge pattern density, width/length ratio, or area/perimeter ratio.

FIG. 4 is a block diagram of a defect diagnosis system 200 used to implement the method 100, constructed according to aspects of the present disclosure in one or more embodiments.

The system 200 includes a data collector 202 designed to collect raw data including defect data. The defect data include defect images collected from the substrate 150. The raw data further include integrated circuit design layout (layout database). The data collector 202 includes software or storing media in organizing and storing the raw data. The data collector 202 includes hardware, such as metrology apparatus, to capture the defect data. For example, the corresponding metrology apparatus may be an optical electrical or analytical tool such as light-scattering tool, microscope, micro-analytical tool, mask and reticle defect tool, particle distribution tool, surface analysis tool, resistivity and contact resistance measurement tool, mobility and carrier concentration measurement tool, film thickness measurement tool, gate oxide integrity test tool, or other suitable test and measurement tool that is able to extract defects of one or more type. In one embodiment, the metrology apparatus may be distributed at different location and remotely connected to the data collector through the network 240.

The system 200 includes a coordinate converter 204 designed to convert coordinate on wafer (CW) to coordinate on database (CD), therefore also referred to as CW-Cd converter. The coordinate converter 204 receives CD data from the data collector 202 and provides CD data as output.

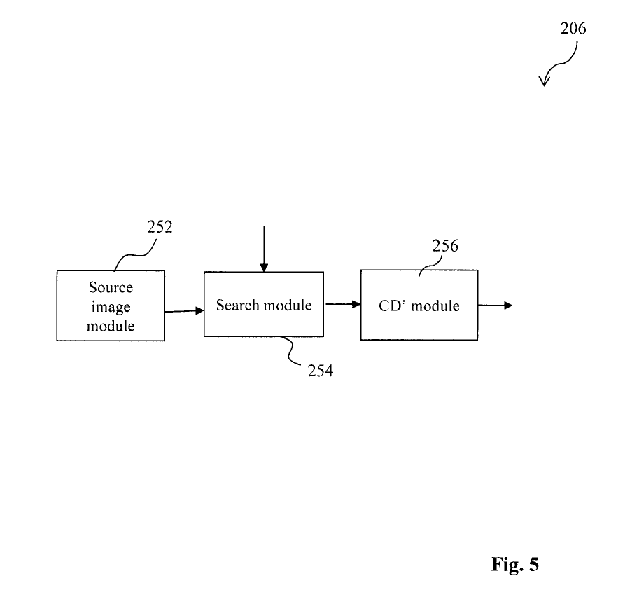

The system 200 includes an image-based defect alignment module 206 designed to implement the image-based defect alignment 116. Particularly, the image-based defect alignment module 206 determines a matched coordinate on database (CD′) by performing image-based defect alignment to IMG. The image-based defect alignment module 206 is further described with reference to FIG. 5 as a block diagram, constructed according to one embodiment. The image-based defect alignment module 206 includes a source image sub-module (or module) 252 to generate a source image (IMG′) from a layout database (DB). The image-based defect alignment module 206 includes a search module 254 to perform a search process. The search process will search the defect image (IMG) from the source image (IMG′) and find the best matched position P as described in the operation 134 of FIG. 2. The search module 254 receives the source image (IMG′) from the source image module 252 and further receives the defect image (IMG) and the defect coordinate on database (CD) from other modules. The image-based defect alignment module 206 includes a module 256 to extract the matched coordinate on database (CD′) based on the best matched position P (therefore this module is also referred to as CD′ module).

The system 200 may further include a compensation module 208 to extract the coordinate compensation value (CV) based on the matched coordinate on database (CD′).

The system 200 may further include a defect binning module 210 to apply a defect binning process to defect images after the coordinate compensation. In one embodiment, the defect binning process is based on one or more factors, such as defect location. Since the defect coordinate mismatch is compensated, the binning process generates more accurate and reliable results.

The system 200 may further include other modules, such as a communication interface 212 to provide an interface for engineer 230 to involve in defect diagnosis. For example, the engineer 230 may analyze the binning result to find out the root cause of the defects.

The system 200 includes both software and hardware and may be connected to a network 240 (such as a local network or the Internet). The system 200 may be further connected to a virtual fab or a part of the virtual fab (described in more detail later). Each functional module and the various functions of the system 200 may be configured and coordinated to implement the defect coordinate mismatch compensation and defect diagnosis.

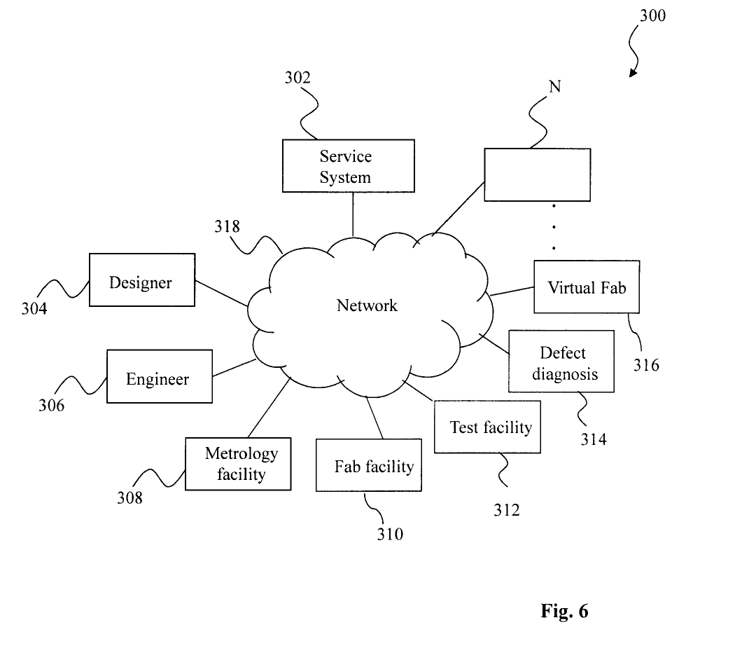

Referring now to FIG. 6, a virtual integrated circuit (IC) fabrication system (a “virtual fab”) 300, to which the system 200 of FIG. 4 may be connected, is illustrated. The virtual fab 300 includes a plurality of entities 302, 304, 306, 308, 310, 312, 314, 316 . . . , N that are connected by a communications network 318. The network 318 may be a single network or may be a variety of different networks, such as an intranet and the Internet, and may include both wireline and wireless communication channels.

In the present example, the entity 302 represents a service system for service collaboration and provision, the entity 304 represents an IC designer, the entity 306 represents an engineer, the entity 308 represents a metrology facility for IC testing and measurement, the entity 310 represents a fabrication (fab) facility, and the entity 312 represents a test facility, the entity 314 represents a defect diagnosis system (the system 200 in the present embodiment), and the entity 316 represents another virtual fab (e.g., a virtual fab belonging to a subsidiary or a business partner). Each entity may interact with other entities and may provide services to and/or receive services from the other entities.

For purposes of illustration, each entity 302-316 may be referred to as an internal entity (e.g., an engineer, designer, an automated system process, a design or fabrication facility, etc.) that forms a portion of the virtual fab 300 or may be referred to as an external entity that interacts with the virtual fab 300. It is understood that the entities 302-316 may be concentrated at a single location or may be distributed, and that some entities may be incorporated into other entities. In addition, each entity 302-316 may be associated with system identification information that allows access to information within the system to be controlled based upon authority levels associated with entity identification information.

The virtual fab 300 enables interaction among the entities 302-316 for the purpose of IC manufacturing, as well as the provision of services. In the present example, IC manufacturing includes receiving an IC order or IC service request (such as failure mode analysis associated with the defects) order and the associated operations needed to produce the IC service request and send them to the corresponding entity, such as the designer, the engineer, fabrication, and testing.

One of the services provided by the virtual fab 300 may enable collaboration and information access in such areas as design, engineering, logistics, and defect control. For example, in the design area, the engineer 306 may be given access to information and tools related to the products via the service system 302. The tools may enable the engineer 306 to perform yield enhancement analyses, analyze the defects and root cause of the defects, view layout information, and obtain similar information. The engineer 306 may collaborate with other engineers using fabrication information regarding pilot yield runs, risk analysis, quality, and reliability. The logistics area may provide various entities with fabrication status, testing results, order handling, and shipping dates. In the defect control area, the engineer 306 may be given access to the defect diagnosis system 314 and other sources such as the metrology facility 308, the fab facility 310, and the test facility via the network 318 to implement defect diagnosis including the defect coordinate mismatch compensation. It is understood that these areas are exemplary, and that more or less information may be made available via the virtual fab 300 as desired.

Another service provided by the virtual fab 300 may integrate systems between facilities, such as between the metrology facility 308 and the fab facility 310. Such integration enables facilities to coordinate their activities. For example, integrating the metrology facility 308 and the fab facility 310 may enable manufacturing information to be incorporated more efficiently into the fabrication process, and may enable wafer data from the metrology tools to be returned to the fab facility 310 for improvement and incorporation.

Thus, the present disclosure provides one embodiment of a method for defect diagnosis to a semiconductor wafer. The method includes collecting raw data that include a defect image (IMG), defect coordinate-on-wafer (CW) and layout database (DB); performing an image-based defect alignment to IMG according to CW and DB; and compensating coordinate mismatch according to the image-based defect alignment.

In one embodiment, the method further includes transferring CW to defect coordinate-on-database (CD) after the collecting raw data and before the performing an image-based defect alignment.

In another embodiment, the compensating the coordinate mismatch further includes extracting a matched coordinate-on-database (CD′) from the image-based defect alignment. In furtherance of the embodiment, the compensating the coordinate mismatch further includes finding a coordinate offset based on CD′ and CD. The coordinate offset is equals to a difference between CD′ and CD. The compensating the coordinate mismatch further includes compensating CW of IMG with the coordinate offset.

In another embodiment of the method, CW is a coordinate of a center point of IMG; the collecting raw data further includes collecting a second defect image with a second CW; and the compensating the coordinate mismatch further includes compensating the second CW of the second defect image with the coordinate offset. In another embodiment, IMG and the second defect image are collected from the semiconductor wafer.

In yet another embodiment, the performing an image-based defect alignment to IMG according to CW and DB includes extracting a source image (IMG′) from DB, wherein IMG′ is centered at CD; searching IMG from IMG′; returning corresponding position P in IMG′ if a matched result is identified; and determining CD′ from the corresponding position P.

In yet another embodiment, IMG has a first size; and the drawing IMG′ from DB includes drawing IMG′ having a second size that is greater than the first size.

The present disclosure also provides another embodiment of a method for defect diagnosis. The method includes collecting raw data that include a defect image (IMG), defect coordinate-on-wafer (CW) and layout database (DB); transferring CW to defect coordinate-on-database (CD); performing an image-based defect alignment to IMG according to CD and DB, identifying a matched coordinate (CD′); and compensating coordinate mismatch according to a compensation value (CV) defined as a difference between CD and CD′.

In one embodiment of the method, the performing an image-based defect alignment to IMG according to CW and DB includes drawing a source image (IMG″) from DB, wherein the source image is centered at CD; searching IMG from IMG′; returning a corresponding position P in IMG′ if a matched result is identified; and determining CD′ from the corresponding position P.

In another embodiment, IMG has a first size; and the drawing IMG′ from DB includes drawing IMG′ having a second size that is greater than the first size. In yet another embodiment, the compensating coordinate mismatch includes compensating CW of IMG with CV.

In yet another embodiment, the collecting IMG includes collecting IMG from a semiconductor wafer having a main pattern and a defect pattern. In yet another embodiment, the main pattern is defined in the layout database.

The present disclosure also provides a system for diagnosing a defect image from a semiconductor substrate. The system includes a data collector designed to collect raw data including the defect image (IMG), defect coordinate on wafer (CW) and layout database (DB). The system includes a conversion module to covert CW to defect coordinate on database (CD); an image-based defect alignment module to determine a matched coordinate on database (CD′) by performing image-based defect alignment to IMG; and a compensation module to extract a compensation value from CD and CD′.

In one embodiment, the system further includes a defect binning module to classifying various defect images. In another embodiment, the image-based defect alignment module further includes a source image module to generate a source image (IMG′) from DB and a search module to search IMG from IMG′. In another embodiment, the image-based defect alignment further includes a module to extract a matched position from the search module and convert the matched position to CD′.

Although embodiments of the present disclosure have been described in detail, those skilled in the art should understand that they may make various changes, substitutions and alterations herein without departing from the spirit and scope of the present disclosure. Accordingly, all such changes, substitutions and alterations are intended to be included within the scope of the present disclosure as defined in the following claims. In the claims, means-plus-function clauses are intended to cover the structures described herein as performing the recited function and not only structural equivalents, but also equivalent structures.

What is claimed is:

1. A method for defect diagnosis to a semiconductor wafer, comprising:
collecting raw data that include a defect image (IMG), defect coordinate-on-wafer (CW) and layout database (DB);
performing an image-based defect alignment to IMG according to CW and DB; and
compensating coordinate mismatch according to the image-based defect alignment.

2. The method of claim 1, further comprising transferring CW to defect coordinate-on-database (CD) after the collecting raw data and before the performing an image-based defect alignment.

3. The method of claim 2, wherein the compensating the coordinate mismatch further includes extracting a matched coordinate-on-database (CD′) from the image-based defect alignment.

4. The method of claim 3, wherein the compensating the coordinate mismatch further includes finding a coordinate offset based on CD′ and CD.

5. The method of claim 4, wherein the coordinate offset is equals to a difference between CD′ and CD.

6. The method of claim 4, wherein the compensating the coordinate mismatch further includes compensating CW of IMG with the coordinate offset.

7. The method of claim 4, wherein
CW is a coordinate of a center point of IMG;
the collecting raw data further includes collecting a second defect image with a second CW; and
the compensating the coordinate mismatch further includes compensating the second CW of the second defect image with the coordinate offset.

8. The method of claim 7, wherein IMG and the second defect image are collected from the semiconductor wafer.

9. The method of claim 4, wherein the performing an image-based defect alignment to IMG according to CW and DB includes:
extracting a source image (IMG′) from DB, wherein IMG′ is centered at CD;
searching IMG from IMG′;
returning corresponding position P in IMG′ if a matched result is identified; and
determining CD′ from the corresponding position P.

10. The method of claim 9, wherein
IMG has a first size; and
the drawing IMG′ from DB includes drawing IMG′ having a second size that is greater than the first size.

11. A method for defect diagnosis, comprising:
collecting raw data that include a defect image (IMG), defect coordinate-on-wafer (CW) and layout database (DB);
transferring CW to defect coordinate-on-database (CD);
performing an image-based defect alignment to IMG according to CD and DB, identifying a matched coordinate (CD′); and
compensating coordinate mismatch according to a compensation value (CV) defined as a difference between CD and CD′.

12. The method of claim 11, wherein the performing an image-based defect alignment to IMG according to CW and DB includes:
drawing a source image (IMG″) from DB, wherein the source image is centered at CD;
searching IMG from IMG′;
returning a corresponding position P in IMG′ if a matched result is identified; and
determining CD′ from the corresponding position P.

13. The method of claim 12, wherein
IMG has a first size; and
the drawing IMG′ from DB includes drawing IMG′ having a second size that is greater than the first size.

14. The method of claim 12, wherein the compensating coordinate mismatch includes compensating CW of IMG with CV.

15. The method of claim 11, wherein the collecting IMG includes collecting IMG from a semiconductor wafer having a main pattern and a defect pattern.

16. The method of claim 15, wherein the main pattern is defined in the layout database.

17. A system for diagnosing a defect image from a semiconductor substrate, comprising:
a data collector designed to collect raw data including the defect image (IMG), defect coordinate on wafer (CW) and layout database (DB);
a conversion module to covert CW to defect coordinate on database (CD);
an image-based defect alignment module to determine a matched coordinate on database (CD′) by performing image-based defect alignment to IMG; and
a compensation module to extract a compensation value from CD and CD′.

18. The system of claim 17 further comprising a defect binning module to classifying various defect images.

19. The system of claim 17, wherein the image-based defect alignment module further includes:
a source image module to generate a source image (IMG′) from DB; and
a search module to search IMG from IMG′.

20. The system of claim 17, wherein the image-based defect alignment module further includes a module to extract a matched position from the search module and convert the matched position to CD′.
